(19) United States
(12) Patent Application Publication
(10) Pub. No.: US 2003/0118695 A1
(43) Pub. Date: Jun. 26, 2003

(54) Edible water-in-oil emulsion with calcium

(75) Inventor: Wilhelmus Adrianus Castenmiller, Vlaardingen (NL)

Correspondence Address: UNILEVER, PATENT DEPARTMENT, 45 RIVER ROAD, EDGEWATER, NJ, 07020, US

(73) Assignee: Unilever Bestfoods North America, Division of Conopco, Inc.

(21) Appl. No.: 10/272,749

(22) Filed: Oct. 17, 2002

(30) Foreign Application Priority Data
Oct. 19, 2001 (EP) 01203988.9

(51) Int. Cl. A23K 1/175

(52) U.S. Cl. 426/74

(57) ABSTRACT

An edible water-in-oil emulsion having an average water droplet size D_{3,3} of 30 μm or lower, comprising a water-insoluble calcium salt, wherein the emulsion comprises calcium sulphate, the amount of calcium in the emulsion is 0.20 weight % or more and the molar ratio [Ca]/[SO₄] in the emulsion is in the range 0.2 to 6.0.

### FIELD OF THE INVENTION

The invention relates to edible water-in-oil emulsions with calcium, especially edible water-in-oil emulsions in a calcium supplemented food product.

### BACKGROUND OF THE INVENTION

Calcium is an essential element in human and animal nutrition. Calcium is the chief supportive element in bones and teeth. Calcium salts make up about 70 percent of bone by weight and give that substance its strength and rigidity. It helps to contract muscles and helps regulate the contractions of the heart. It plays a role in the transmission of nerve impulses and in the clotting of blood. Calcium is involved in the stimulation of contractions of the uterus during childbirth and in the production of milk. It also regulates the secretion of various hormones and aids in the functioning of various enzymes within the body.

Calcium can be obtained from a variety of dietary sources. Food sources high in calcium include milk, cheese, yogurt, and other dairy products and leafy green vegetables. However these products are often not consumed in sufficient quantities to obtain the recommended dietary levels of calcium. Therefore calcium supplemented food products have been developed and these are available for the consumers in numerous forms.

The invention relates to calcium supplemented food products that are in the form of a water-in-oil emulsion. The known calcium supplemented water-in-oil emulsions can be divided into two groups, one group being emulsions comprising a water soluble calcium salt and the second group being emulsions comprising a water insoluble calcium salt. Water insoluble is herein understood to include salts that are only slightly (<10 wt. %) soluble in water.

Emulsions comprising a water soluble calcium salt are limited in their applicability, since at high concentrations of calcium, e.g. 0.2 wt. % or more, which are often desired in a 10 calcium supplemented food product, the solubility of the calcium salt may be insufficient. Moreover soluble calcium salts have the effect to give a bitter taste to the calcium supplemented food product.

These disadvantages can be overcome with a water insoluble calcium salt, but with insoluble calcium salt other problems may arise.

An emulsion comprising a water insoluble calcium salt is known from WO 00/54838, which describes a liquid calcium containing composition, suitable as food product. On page 6, second paragraph of WO 00/54838 several insoluble calcium salts are mentioned.

Research Disclosure (1998) 294778, by Andersen L. P., Grindsted, discloses a calcium-fortified margarine comprising 1 wt. % calcium phosphate. A daily intake of 25 g of this margarine contributed 80 mg calcium.

We have found that when the usual insoluble calcium salts, such as calcium phosphates, are used in the preparation of a water-in-oil emulsion having an average water droplet size D_{3,3} of 30 μm or lower, wear of the processing apparatus occurs.

### SUMMARY OF THE INVENTION

It is an object of the invention to provide an edible water-in-oil emulsion having an average water droplet size D_{3,3} of 30 μm or lower, comprising a water-insoluble calcium salt, which during production of the emulsion gives reduced wear in processing apparatus.

Another object of the invention is to provide an edible water-in-oil emulsion suitable as calcium supplement for humans.

Another object according to the invention is to provide a microbiologically stable edible water-in-oil emulsion.

Yet another object according to the invention is to provide a calcium supplemented food product having good organoleptical characteristics.

One or more of these objects is achieved according to the invention wherein the emulsion comprises calcium sulphate, the amount of calcium in the emulsion is 0.20 weight % or more and the molar ratio [Ca]/[SO₄] in the emulsion is in the range 0.2 to 6.0.

### DETAILED DESCRIPTION OF THE INVENTION

The following definitions will be used throughout the description and in the claims. Where ranges are mentioned, the expression from a to b is meant to indicate from and including a, up to and including b, unless otherwise indicated. The expressions ‘oil’ and ‘fat’ are used interchangeably.

A water-in-oil emulsion herein includes all emulsions that comprise oil (or fat) as a continuous phase and water as a dispersed phase. Multiple water-in-oil emulsions, such as duplex emulsions are included.

The average water droplet size D_{3,3} of the emulsion according to the invention, as defined herein in under examples, should be 30 μm or lower. Preferably the average water droplet size D_{3,3} is 20 μm or lower, more preferably 10 μm or lower, especially 1-10 μm. The lower the average water droplet size, the higher the microbiological stability of the water in oil emulsion. Moreover the advantage of reduced wear becomes more pronounced at lower average water droplet sizes.

The edible water-in-oil emulsions may be incorporated in food products for humans. Such food products are herein called emulsion food products. Edible is herein defined as being suitable for human consumption. Preferably the emulsion food products substantially consist of the emulsion according to the invention, e.g. at least 50 wt. %, more preferably at least 70 wt. %, most preferably at least 90 wt. % of-the emulsion food product. The emulsion food products include butters, margarines, spreads, sandwich spreads, slimming products and meal replacers. Other products as long as they comprise water-in-oil emulsions are also possible. Preferably the water-in-oil emulsion food product is a spread.

Preferably the water-in-oil emulsion is consumed at regular intervals, most preferably on a daily base. This means that the dietary calcium intake is more constant in time. Preferred emulsion food products are therefore butters, margarines (80 wt. % fat or more), spreads, such as reduced fat spreads (80-60 wt. % fat) and low fat spreads (40 wt. % fat or lower). Other preferred products are slimming products and meal replacers.

Preferably the water-in-oil emulsion comprises 55 weight % or more of a fat phase. With these emulsions wear of the processing apparatus with conventional calcium salt is most prominent.

The amount of calcium sulphate is determined by the desired calcium supplementation, which depends on the average daily consumption of the emulsion. Preferably the emulsion comprises 0.20 weight % or more of, more preferably 0.40 weight % or more of calcium.

In the emulsion food product, the molar ratio [Ca]/[SO₄], determined as indicated in this specification is 0.2 to 6, more preferably 0.5 to 4, most preferably 0.8 to 1.2.

The calcium content [Ca] of the emulsion food product may be determined by methods available to the person skilled in the art. Herein the calcium content is measured according to AOAC official method 991.25 using atomic absorption spectrophotometric and colorimetric methods.

The presence of SO₄ in the emulsion food product may be determined by methods available to the person skilled in the art. The sulphate content [SO₄] may be calculated from and closely approximated by the sulphur content of the food product, since no substantial amounts of other sulphur 30 containing ingredients are present. The sulphur content of an emulsion food product may be determined using the AOAC official method 955.48, involving a microchemical determination of sulphur with a gravimetric Carius combustion method.

After the presence of calcium and sulphate, determined as defined here above, are determined, it can be shown that calcium sulphate is present using an infrared technique. A method may be used, which involves separation of the salts from the emulsion food product, by carefully heating and burning a weighed sample of the emulsion food product and subsequently igniting the charred residue at 550-600 degrees Celsius until all carbon has burned. The residue (ash) is analyzed using infrared spectroscopy and the pellet technique as described in Stimson M., O'Donnel J. M., J. Am. Chem. Soc., 74, 1805 (1952) and Schiedt U., Reinwein, H., Z. Naturforsch, 7, 270 (1952). The presence and identity of calcium sulphate can be determined by spectral comparison with commercially available infrared spectra as shown in Sadtler's Spectral Databases, Bio-Rad Laboratories, Philadelphia, Pa. 19104, USA, 1999.

The calcium source used herein may be pure calcium sulphate or calcium sulphate mixed with other calcium salts, other salts or non-salt additives. In case the calcium source is calcium sulphate, the calcium sulphate may be anhydrous or may contain crystal water. Suitable hydrated forms are the hemihydrate CaSO₄.0.5H₂0 (also called plaster of Paris) and the dehydrate CaSO₄.2H₂0 (also called gypsum). Calcium sulphate has food grade status in the European Union (E516).

Preferably the calcium source has a mean particle size of 30 μm or lower, more preferably a mean particle size of 15 μm or lower. The mean particle size of calcium salt in an emulsion food product may be determined according to methods available to the person skilled in the art, for instance using a microscope and a particle size analyzer.

Processing apparatus is herein meant to include all conventional apparatus for preparing a water-in-oil emulsion. These include votators comprising scraped surface heat exchangers, pin stirrers, pumps etc., and also homogenisers, filling machines etc.

The invention is further illustrated by the following examples.

### EXAMPLES

Analysis Techniques

The following analysis techniques were used for determining properties according the invention:

water droplet size D_{3,3.} The water droplet size was measured using a well known low resolution NMR measurement method. Reference is made to Alderliesten, M.; Part.Part. Syst. Charact. 8 (1991), 237-241.

serum pH. Determined by titration of the aqueous phase after phase phase separation of the emulsion by centrifugation

calcium content. Measured according to AOAC official method 991.25 using atomic absorption spectrophotometric/colorimetric technique

Materials

The specifications and/or origin of the components used, including the calcium salts, are given hereunder:

Margarine fat blend:

70 wt. % of a randomly interesterified mixture consisting of:

20 wt. parts of palm oil

30 wt. parts of coconut oil

40 wt. parts of soybean oil

10 wt. parts of soybean oil hydrogenated to melting point 60° C.;

15 wt. % palm oil;

5 wt. % coconut oil;

10 wt. % soybean oil

Bolec ZT: native soy bean lecithin ex Unimills Zwijndrecht NL

Bolec MT hydrolysed soy bean lecithin ex Unimills Zwijndrecht NL

Hymono 8903: distilled saturated monoglyceride ex Quest

Hymono 7804: distilled unsaturated monoglyceride ex Quest

β-carotene colorant ex Hoffmann-La Roche, 1% solution in sunflower oil

sour whey powder

Geltex pig skin gelatine ex Extraco

Keltrol RD xanthan gum ex Kelco

NaCl, K-sorbate, citric acid, tap water: standard laboratory components

Calcium sulphate ex HCI Chemicals Benelux, CaSO₄.0.5H₂O, 27.9 wt. % calcium

Calcium sulphate ex Riedel de Haën, CaSO₄.2H₂O, 23.3 wt. % calcium

Calcium phosphate type (TCP) C13-13 ex Budenheim, β-tricalcium phosphate, Ca₃(PO₄)₂, 38.5% calcium, bulk density 550 g/liter

Lactoval QM ex DMV/Campina, calcium complex from milk, mainly calcium phosphate plus citrate, 25.8% calcium.

### EXAMPLES 1,2 AND COMPARATIVE EXPERIMENTS A, B

In example 1, a 40 wt. % fat spread was prepared according to the composition given in table 1.

Example 2 and the comparative experiments A-B were conducted exactly as example 1, except for the following modifications:

In examples 2 and B the pH of the water phase was 5.0 and in comparative experiments A-B tricalcium phosphate was used instead of calcium sulphate.

The pH of the water phase was measured and adjusted to the values given in table 1 by addition of citric acid.

TABLE 1
Spread compositions

| | Amount | Amount | Amount | Amount |
|---|---|---|---|---|
| | (wt. %) | (wt. %) | (wt. %) | (wt. %) |
| | Example | Example | Comp. Exp. | Comp. Exp. |
| Component | 1 | 2 | A | B |
| Fat blend | 39.71 | 39.71 | 39.71 | 39.71 |
| Bolec ZT | 0.05 | 0.05 | 0.05 | 0.05 |
| Hymono 8903 | 0.16 | 0.16 | 0.16 | 0.16 |
| β-carotene | 0.08 | 0.08 | 0.08 | 0.08 |
| (1% in Sunflower | | | | |
| oil) | | | | |
| Total fat phase | 40.00 | 40.00 | 40.00 | 40.00 |
| Tap water | up to 60 | up to 60 | up to 60 | up to 60 |
| Sour whey powder | 0.27 | 0.27 | 0.27 | 0.27 |
| NaCl | 0.48 | 0.48 | 0.48 | 0.48 |
| K-sorbate | 0.12 | 0.12 | 0.12 | 0.12 |
| Gelatin | 1.10 | 1.10 | 1.10 | 1.10 |
| Citric acid | To pH 4.6 | To pH 5.0 | To pH 4.6 | To pH 5.0 |
| Xanthan gum | 0.10 | 0.10 | 0.10 | 0.10 |
| Calcium salt | | | | |
| TCP C13-13 | | | 1.27 | 1.27 |
| CaSO4.0.5H2O | 1.74 | 1.74 | | |
| PH waterphase set | 4.6 | 5.0 | 4.6 | 5.0 |
| Total water phase | 60.00 | 60.00 | 60.00 | 60.00 |
| Total | 100.00 | 100.00 | 100.00 | 100.00 |

Preparation of Spreads

100 kg of a premix composition was prepared from a fat phase and a water phase. The fat blend was melted at 60° C., and the fat-soluble components were added. Sour whey powder, NaCl, K-sorbate and gelatin were dissolved in this order in tap water in the premix tank. Xanthan gum was added, and finally the calcium salt was dispersed in the aqueous phase. The pH was set at 4.6-5.0 using citric acid. The amount of citric acid required to bring the water phase to the desired pH value was measured. Then the fat phase was added under stirring.

The premix was processed in a Votator line of configuration AACAC (numbering A1A2C1A3C2), wherein A designates a scraped surface heat exchanger, and C designates a pen stirred crystallizer. The A-units consist of a stainless steel cylinder cooled at the outer surface with ammonia. The A-units are equipped with a rotor axis on which 2 rows of 2 stainless steel scraper blades are mounted (weight about 15 gram each). The open annular space between the rotor and the cylinder is 3 mm in A1, 6 mm in A2 and 8 mm in A3. The content of the A-units (between the rotor and the cylinder) is 0.13 liter for A1, 0.235 liter for A2 and 0.295 liter for A3. The content of the C-units is 2.1 liter (C1) and 3.8 liter (C2). The votator units were operated with the following rotational speed: A-units at 350 rpm, C1 at 840 rpm and C2 at 350 rpm.

The cooling of the votator units was set in such a way that the amount of solid fat crystallised in each unit remained the same for each for each experiment. The outlet temperatures and solid fat levels of the emulsion after each unit are given in table 2.

TABLE 2
Processing conditions for examples 1 and 2 and
comparative experiments A and B. “nm”
means: not measured

| | | | Ex- | Ex- | | |
|---|---|---|---|---|---|---|
| Processing | | | ample | ample | Comp. | Comp. |
| Unit | Property | Unit | 1 | 2 | Exp. A | Exp. B |
| Pump | Line pressure | bar | 9 | nm | 10 | Nm |
| A1-UNIT | Outlet | ° C. | 23.0 | 23.1 | 23.1 | 22.4 |
| | temperature | | | | | |
| | Outlet solids | % | 2.3 | 2.6 | 2.1 | 2.7 |
| A2-UNIT | Outlet | ° C. | 16.1 | 16.1 | 16.2 | 16.2 |
| | temperature | | | | | |
| | Outlet solids | % | 3.9 | 4.8 | 4.0 | 4.0 |
| C1-UNIT | Outlet | ° C. | 19.5 | 19.6 | 19.3 | 19.5 |
| | temperature | | | | | |
| | Outlet solids | % | 9.0 | 9.3 | 8.8 | 8.5 |
| A3-UNIT | Outlet | ° C. | 15.4 | 15.2 | 15.5 | 14.6 |
| | temperature | | | | | |
| | Outlet solids | % | 10.0 | 10.3 | 9.6 | 9.6 |
| C2-UNIT | Outlet | ° C. | 16.2 | 16.8 | 15.2 | 15.2 |
| | temperature | | | | | |
| | Outlet solids | % | 10.6 | 10.7 | nm | 10.4 |
| REWORK | Temperature | ° C. | 80 | 65 | 80 | 65 |
| MELTER | | | | | | |

In the premix tank and the first 2 A-units the emulsion is water-continuous. In the first C-unit (C1) inversion takes place, such that in the third A-unit (A3) the emulsion is oil-continuous. continuous. The emulsion was processed at a capacity of 100 kg/hr. The product which exited from the C2-unit was melted in a rework melter, and fed back into the premix tank, in order to save on the amount of materials used. One experiment lasted up to 5 hours.

Wear of the processing equipment was quantified by measuring the weight loss of the scraper blades in the A-units of the votator. Before starting, all blades were given a numerical engraving: this allowed mounting the blades always on the same position on the rotor after each time the blades were weighed. The weight loss in the first 2 A-units (low viscosity, water-continuous emulsion) appeared to be negligible. The weight loss from the A3 blades was averaged over the 4 blades and is given in table 3, in mg and in mg/hr.

The results are given in table 3.

TABLE 3
Results of examples 1 and 2 and comparative
experiments A and B: weight loss of A3 blades

| | | | | | Molar | | |
|---|---|---|---|---|---|---|---|
| | | | | | ratio | Water | |
| | | | | | [Ca]/ | droplet | |
| | Run | Weight | Weight | Calcium | [SO₄] | size | |
| Ex- | time | loss | loss | content | Cal- | D3, 3 | Serum |
| ample | (hr) | (mg) | (mg/hr) | (wt. %) | culated | (μm) | pH |
| 1 | 5 | 9 | 1.8 | 0.45 | 1.0 | 20.1 | 5.0 |
| 2 | 5 | −2 | −0.4 | 0.48 | 1.0 | 17.4 | 5.4 |
| A | 5 | 72 | 14.4 | 0.50 | No SO₄ | 20.7 | 4.8 |
| B | 4 | 35 | 8.8 | 0.49 | No SO₄ | 15.1 | 4.4 |

The results in table 3 show that when calcium sulphate is used in the emulsion instead of conventional calcium salt, the wear in the processing apparatus is considerably reduced (the negative weight loss value measured in example 2 is interpreted to be zero within the measuring accuracy).

### EXAMPLES 3 AND 4 AND COMPARATIVE EXPERIMENTS C AND D

In these examples, a 60 wt. % fat spread was produced from the components as given in table 4. Two different calcium salts were used in examples 3 and 4. Comparative experiments C and D were conducted exactly as examples 3 and 4, but a different calcium salt and xanthan concentration as indicated in table 4 were used.

TABLE 4
Spread compositions

| | Amount | Amount | Amount | Amount |
|---|---|---|---|---|
| | (wt. %) | (wt. %) | (wt. %) | (wt. %) |
| | Example | Example | Comp. Exp. | Comp. Exp. |
| Component | 3 | 4 | C | D |
| Fat blend | 59.39 | 59.39 | 59.39 | 59.39 |
| Bolec MT | 0.20 | 0.20 | 0.20 | 0.20 |
| Hymono 8903 | 0.25 | 0.25 | 0.25 | 0.25 |
| Hymono 7804 | 0.10 | 0.10 | 0.10 | 0.10 |
| β-carotene | 0.06 | 0.06 | 0.06 | 0.06 |
| (1% in Sunflower | | | | |
| oil) | | | | |
| Total fat phase | 60.00 | 60.00 | 60.00 | 60.00 |
| Tap water | up to 40 | up to 40 | up to 40 | up to 40 |
| Sour whey powder | 0.40 | 0.40 | 0.40 | 0.40 |
| NaCl | 0.30 | 0.30 | 0.30 | 0.30 |
| K-sorbate | 0.06 | 0.06 | 0.06 | 0.06 |
| Citric acid | 0.01 | 0.01 | 0.01 | 0.01 |
| Lactic acid | To pH 4.6 | To pH 4.6 | To pH 4.6 | To pH 4.6 |
| Xanthan gum | 0.004 | 0.004 | 0.004 | 0.02 |
| Calcium salt | | | | |
| Lactoval QM | | | 1.96 | 1.96 |
| CaSO4.0.5H2O | 1.74 | | | |
| CaSO4.2H2O | | 2.06 | | |
| PH waterphase set | 4.6 | 4.6 | 4.6 | 4.6 |
| Total water phase | 40.00 | 40.00 | 40.00 | 40.00 |
| Total | 100.00 | 100.00 | 100.00 | 100.00 |

Preparation of the fat phase and the water phase and the analysis of the emulsion food product were done as in example 1. In the preparation of the water phase, the indicated amount of citric acid was added, and the pH value (pH set) was further adjusted using the lactic acid. In these examples, the complete fat phase was first prepared in the premix tank, and then the water phase was added under stirring.

The votator was now operated in an ACAAC mode (A1C1A2A3C2). The A-units had a content of 0.15 liter and an annular space of 3.5 mm, and were operated at 600 rpm. The C-units had a content of 1.5 and 3 liter resp., and were operated at 250 and 150 rpm resp. The processing conditions are given in table 5.

TABLE 5
Processing conditions for examples 3 and 4 and
comparative experiments C and D

| | | | Ex- | Ex- | | |
|---|---|---|---|---|---|---|
| Processing | | | ample | ample | Comp. | Comp. |
| Unit | Property | Unit | 3 | 4 | Exp. C | Exp. D |
| Pump | Line pressure | bar | 29 | 30 | 30 | 19 |
| A1-UNIT | Outlet | ° C. | 26 | 26 | 26 | 26 |
| | temperature | | | | | |
| | Outlet solids | % | 2 | 2.5 | 1.5 | 1.1 |
| A2-UNIT | Outlet | ° C. | 26.5 | 26.7 | 24.5 | 25.2 |
| | temperature | | | | | |
| | Outlet solids | % | 1.4 | 2.1 | 2 | 1.9 |
| C1-UNIT | Outlet | ° C. | 17 | 17 | 15.6 | 16.5 |
| | temperature | | | | | |
| | Outlet solids | % | 3.9 | 4.4 | 3.8 | 4 |
| A3-UNIT | Outlet | ° C. | 13 | 13 | 10 | 10 |
| | temperature | | | | | |
| | Outlet solids | % | 8.8 | 8.4 | 8.2 | 8.6 |
| C2-UNIT | Outlet | ° C. | 14.1 | 15 | 14.2 | 14 |
| | temperature | | | | | |
| | Outlet solids | % | 11.4 | 11.7 | 13.2 | 13.8 |
| REWORK | Temperature | ° C. | 60 | 60 | 60 | Not |
| MELTER | | | | | | used |

In comparative experiment C at longer duration, the first day was ended after 5 hours, and on the second day the process was started again with a new freshly prepared premix mixture. Weighing of the A-unit blades was done after each daily experiment, to monitor the progression of abrasion and to prevent excessive damage to the A-unit cylinders.

Comparative experiment D was carried out as comparative experiment C with some modifications. In the preparation of the water phase, the Lactoval QM powder was dispersed as the first component, and the xanthan gum concentration was 0.02 wt. %. 500 kg of premix was prepared, and the processed spread was not melted and not recycled back into the premix tank. The 3 A-units A1, A2 and A3 had a content of 0.295, 0.235 and 0.13 liter respectively, and an annular space of 8, 6 and 3 mm resp.

The weight loss in the first 2 A-units (low viscosity, water-continuous emulsion) appeared to be negligible. The weight loss from the A3 blades was averaged over the 4 blades and is given in table 6, in mg and in mg/hr.

The results of examples 3 and 4 and comparative experiments C and D, determined in accordance to example 1, are given in table 6.

TABLE 6
Results of examples 3, 4 and comparative experiments
C, D. “nm” means: not measured

| | | | | | Molar | | |
|---|---|---|---|---|---|---|---|
| | | | | | ratio | | |
| | | | | | [Ca]/ | | |
| | Run | Weight | Weight | Calcium | [SO₄] | | |
| Ex- | time | loss | loss | content | Cal- | D3, 3 | Serum |
| ample | (hr) | (mg) | (mg/hr) | (wt. %) | culated | (μm) | pH |
| 3 | 5 | 3 | 0.6 | 0.512 | 1.0 | Nm | 5.3 |
| 4 | 5 | 1 | 0.2 | 0.495 | 1.0 | Nm | 4.9 |
| C | 10 | 31 | 3.1 | 0.53 | No SO₄ | 8.0 | 5.6 |
| D | 5 | 14 | 2.8 | 0.54 | No SO₄ | 9.1 | 4.2 |

The results in table 6 show that in 60 wt. % fat spreads the two types of calcium sulphate used give less wear in the processing apparatus compared to conventional calcium complex salt.

1. Edible water-in-oil emulsion having an average water droplet size D_{3,3} of 30 μm or lower, comprising a water-insoluble calcium salt, wherein the emulsion comprises calcium sulphate, the amount of calcium in the emulsion is 0.20 weight % or more and the molar ratio [Ca]/[SO₄] in the emulsion is in the range 0.2 to 6.0.

2. Edible water-in-oil emulsion according to claim 1, wherein the emulsion has a water droplet size D_{3,3} of 20 μm or less.

3. Edible water-in-oil emulsion according to claim 1 or 2, wherein the emulsion comprises 0.40 weight % or more of calcium.

4. Edible water-in-oil emulsion according to claim 1, wherein the molar ratio [Ca]/[SO₄] is in the range 0.5 to 4.0.

5. Edible water-in-oil emulsion according to claim 4, wherein the molar ratio [Ca]/[SO₄] is in the range 0.8 to 1.2.

6. Edible water-in-oil emulsion according to claim 1, wherein the emulsion comprises 55 weight % or more of a fat phase.

7. Edible water-in-oil emulsion according to claim 1, wherein the calcium sulphate has a mean particle size D_{3,3} of 30 μm or lower.

8. Edible water-in-oil emulsion according to claim 7, wherein the calcium sulphate has a mean particle size D_{3,3} of 15 μm or lower.
